(19) United States
(12) Patent Application Publication
(10) Pub. No.: US 2007/0062927 A1
(43) Pub. Date: Mar. 22, 2007

(54) Steam generator system for a household oven

(76) Inventors: Joel Matthew Sells, Hartford, MI (US); John Piero Doyle, Buguggiate (VA) (IT); Davide Gerola, Comerio (IT); Stephan A. Lemons, Michigan city, IN (US); Marco Poma, Stevensville, MI (US); Malcolm Reay, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/220,258

(22) Filed: Sep. 6, 2005

(51) Int. Cl. A21B 1/22; A21B 1/00; F27D 11/00

(52) U.S. Cl. 219/401

(57) ABSTRACT

A household oven comprises a housing defining a cooking cavity, a water supply, and a steam generator having an evaporation element fluidly coupled to the water supply and configured to generate steam for introduction into the cavity in response to water being supplied to the evaporation element. A fluid control element fluidly couples the water supply to the steam generator and is operable to supply a metered amount of water to the evaporation element.

### BACKGROUND OF THE INVENTION

1. Field of the Invention

The invention relates to a household oven with a steam system that introduces steam into a cooking cavity

2. Description of the Related Art

Combi ovens typically comprise a heating system, as in a conventional oven, for heating a cooking cavity and a steam system for generating steam that is distributed within the cooking cavity to facilitate the baking process. Many types of steam systems have been developed for use with combi ovens. One type of steam system comprises a boiler system external from the cooking cavity, and the boiler system holds a relatively large volume of water that immerses a heating element. The heating element heats the volume of water to at least the boiling point of water to convert the water into steam, and the steam flows from the boiler system into the cavity. In this type of system, the cooking cycle must account for the time required to heat the volume of water and include a delay for introducing the steam into the cavity. Additionally, the boiler system must store an amount of water sufficient to submerge the heating element, and storing such an amount of water can consume some of the limited space in an oven. Another type of steam system follows the same principle, except that the heating element and the volume of water are located in the cavity, usually at a bottom portion of the cavity. Thus, the steam system utilizes space within the cooking cavity and thereby reduces the amount of space available for cooking, which can be a feature that a customer evaluates when deciding to purchase an oven.

Other types of steam systems involve introducing water through a pipe or nozzle that directs the water toward an oven heating element of the heating system. The water vaporizes at the oven heating element and is dispersed in the cavity by a fan. While these systems generate steam more rapidly than boiler systems, they depend on the heating system for generation and dispersion of the steam, and the water must be accurately directed toward the oven heating element, which can potentially lead to an insufficient amount of steam. Additionally, spraying water onto the oven heating element cools the oven heating element and reduces its output. Such an environment is not conducive to maintaining the cooking cavity at a desired cooking temperature. Thus, it is desirable to have an oven with a steam system that rapidly generates steam in a controlled manner.

### SUMMARY OF THE INVENTION

An oven according to one embodiment of the invention comprises a housing defining a cooking cavity, a water supply, a steam generator having an evaporation element for generating steam that is introduced into the cooking cavity, a fluid control element fluidly coupling the water supply to the steam generator and operable to supply a metered amount of water to the evaporation element, and a controller for implementing a steam cooking cycle and operably coupled to the steam generator and the fluid control element to supply the metered amount of water to the evaporation element to generate the steam as demanded by the steam cooking cycle.

The metered amount of water can correspond to an amount of water required to sustain a desired rate of steam generation to meet the demand by the steam cooking cycle.

The steam generator can be configured to convert the metered amount of water to steam substantially instantaneously when the metered amount of water is supplied to the evaporation element.

The steam generator can be located inside the cavity or the steam generator can be located exteriorly of the cavity.

The steam generator can comprise an inlet for receiving water from the water supply and a steam outlet operably connected to the cavity for introducing steam into the cavity. Water that enters the steam generator through the inlet is directed onto the evaporation element.

The oven can further comprise a water reservoir fluidly coupled between the water supply and the steam generator. The water reservoir can be positioned above the evaporation element. The fluid control element can be a pump.

The water supply can be a main water supply that provides pressurized water. The oven can further comprise a pressure regulator upstream of the steam generator to reduce the pressure of the water. The fluid control element can be a valve.

The oven can further comprise a water filter upstream of the steam generator.

A household oven according to another embodiment of the invention comprises a housing defining a cooking cavity, a water supply, and a steam generator located exteriorly of the cavity and having an evaporation element fluidly coupled to the water supply and configured to generate steam for introduction into the cavity in response to water being supplied to the evaporation element.

The steam generator can be mounted to the housing. The steam generator can be mounted to a rear wall of the housing.

The household oven can further comprise a fluid control element fluidly coupling the water supply to the steam generator and operable to supply a metered amount of water to the evaporation element. The metered amount of water can correspond to an amount of water required to sustain a desired rate of steam generation in accordance with a steam cooking cycle.

The water supply can be a main water supply that provides pressurized water. The household oven can further comprise a pressure regulator upstream of the steam generator to reduce the pressure of the water. The fluid control element can be a valve.

The household oven can further comprise a water reservoir fluidly coupled between the water supply and the steam generator. The fluid control element can be a pump.

The household oven can further comprise a water filter upstream of the steam generator.

The steam generator can be configured to convert the water to steam substantially instantaneously when the water is supplied to the evaporation element.

### BRIEF DESCRIPTION OF THE DRAWINGS

In the drawings:

FIG. 1 is a perspective view of an exemplary automatic household oven.

FIG. 2 is a schematic view of the oven of FIG. 1.

FIG. 3 is a schematic diagram illustrating a control system of the oven of FIG. 1.

FIG. 4 is a schematic view of the oven of FIG. 1 with a steam system having an instantaneous steam generator according to one embodiment of the invention.

FIG. 5 is a schematic view of the oven of FIG. 1 with a steam system having an instantaneous steam generator according to another embodiment of the invention.

### DESCRIPTION OF EMBODIMENTS OF THE INVENTION

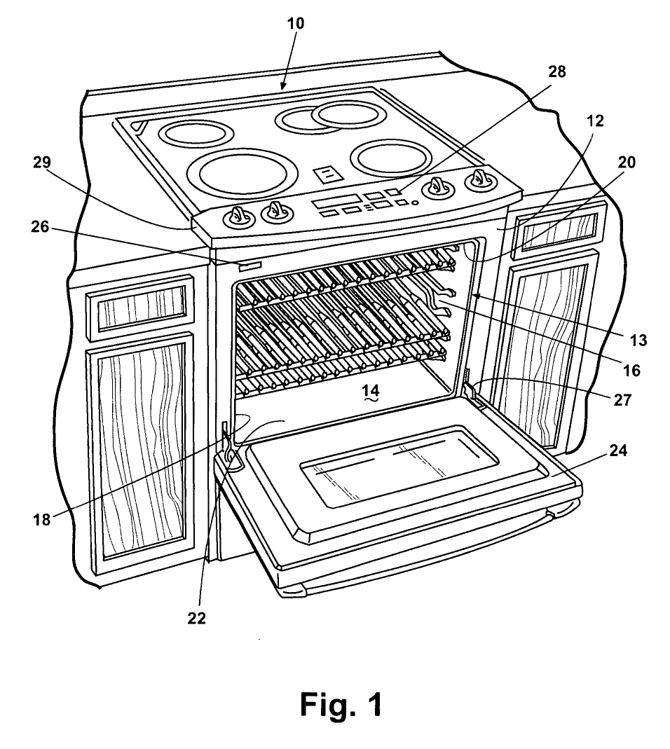

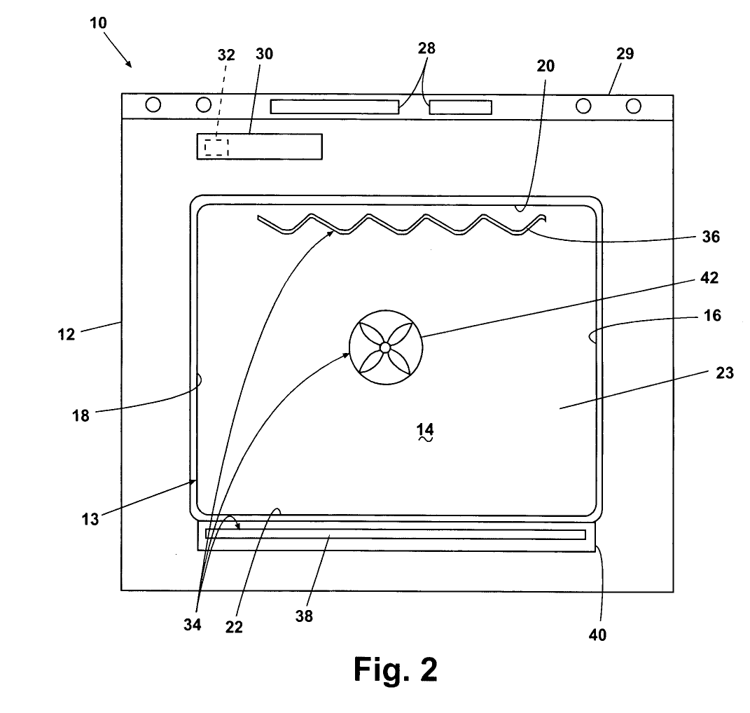

Referring now to the figures, FIG. 1 illustrates an exemplary automatic household oven 10 that can be equipped with a steam system having an instantaneous steam generator according to one embodiment of the invention. The oven 10 comprises a cabinet 12 with an open-face housing 13 having a pair of spaced side walls 16, 18 joined by a top wall 20, a bottom wall 22, and a rear wall 23 (FIG. 2) to define an open-face cooking cavity 14. A door 24 pivotable at a hinge 27 selectively closes the cavity 14, and a sensor 26 detects an open position of the door 24 and a closed position of the door 24. When the door 24 is in the open position, a user can access the cavity 14, while the door 24 in the closed position prevents access to the cavity 14 and seals the cavity 14 from the external environment.

The oven 10 further comprises a console 29 with a control panel 28 having a user interface accessible to the user for inputting desired cooking parameters, such as temperature and time, of manual cooking cycles or for selecting automated cooking cycles. The user interface can comprise, for example, a push button, a rotatable knob, a touch pad, a touch screen, or a voice command unit. The control panel 28 communicates with a controller 30 located in the cabinet 12, as shown in FIG. 2. The controller 30 can be a proportional-integral-derivative (PID) controller or any other suitable controller, as is well-known in the automatic oven art. The controller 30 stores data, such as default cooking parameters, the manually input cooking parameters, and programs for the automated cooking cycles, receives input from the control panel 28, and sends output to the control panel 28 for displaying a status of the oven 10 or otherwise communicating with the user. Additionally, the controller 30 includes a timer 32 for tracking time during the manual and automated cooking cycles.

With continued reference to FIG. 2, the oven 10 further comprises a heating system 34 having an upper heating element 36, commonly referred to as a broiler, and a lower heating element 38. The schematic illustration of FIG. 2 shows the lower heating element 38 as being hidden or mounted beneath the cooking cavity bottom wall 22 in a heating element housing 40. Heat from the lower heating element 38 conducts through the bottom wall 22 and into the cavity 14. Alternatively, the lower heating element 38 can be mounted inside the cavity 14, as is well-known in the oven art. Further, the upper and lower heating elements 36, 38 can be mounted at the side walls 16, 18 of the cavity 14, as disclosed in U.S. Pat. No. 6,545,251 to Allera et al., which is incorporated herein by reference in its entirety. The heating system 34 according to the illustrated embodiment further comprises a convection fan 42 that circulates air and steam, when present, within the cavity 14. The convection fan 42 can be any suitable fan and can be mounted in any suitable location of the cavity 14, such as in the rear wall 23. The heating system 34 can include a convection heating element (not shown) located near the convection fan 42 to ensure that the convection fan 42 circulates heated air. The particular type of heating system is not germane to the invention; the heating system 34 shown and described herein is for illustrative purposes only and is not meant to limit the invention in any manner.

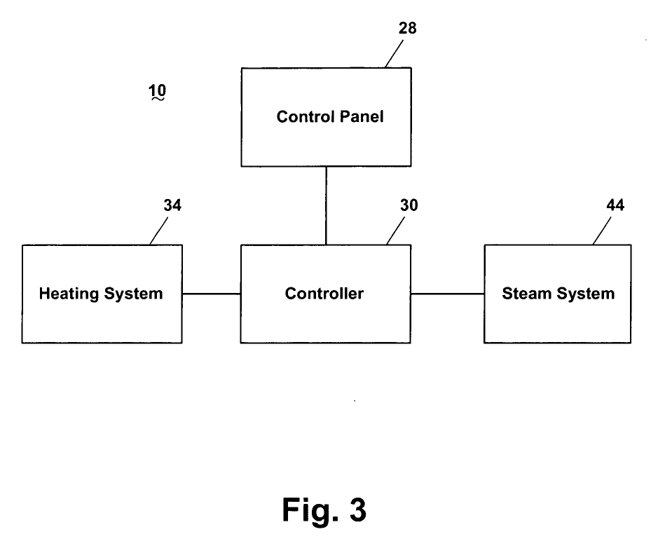

FIG. 3 is a block diagram that schematically illustrates a control system of the oven 10. The control system comprises the controller 30, which operably communicates with the control panel 28, as described above, the heating system 34, and a steam system 44. The controller 30 instructs the heating system 34 to activate or deactivate the upper heating element 36, the lower heating element 38, the convection fan 42, and the convection heating element (not shown), either all together, individually, or in groups, and provides instructions regarding the desired temperature of the cavity 14 and the rate at which the heating system 34 heats the cavity 14. Similarly, the controller 30 instructs the steam system 44 to activate or deactivate to provide to the cavity 14 a desired amount of steam at a desired steam generation rate corresponding to a desired relative humidity in the cavity 14.

Ovens having a heating system and a steam system are commonly referred to as combi ovens. The heating system can be employed alone, as in a traditional oven, or in combination with the steam system. When both the heating system 34 and the steam system 44 are utilized, the steam system 44 functions as a supplement or accessory for the heating system 34. Alternatively, the steam system 44 can be used alone for cooking with steam only.

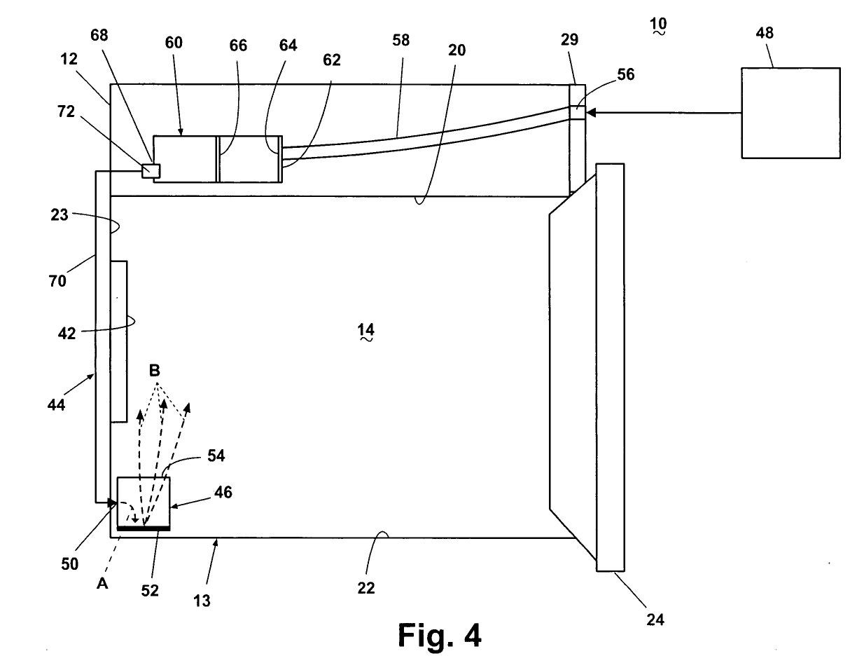

The steam system 44 according to one embodiment of the invention is illustrated schematically in FIG. 4 and comprises a steam generator 46 that, according to the illustrated embodiment, is located in the cavity 14. When the steam generator 46 is located in the cavity, it is preferably sized and positioned so that it utilizes minimum space in the cavity 14 to maximize space available for cooking. For example, the steam generator 46 can be positioned in a rear area of the cavity 14 beneath a lowest position of a cooking rack. The steam generator 46 receives water from a water supply 48 through an inlet 50, as indicated by an arrow labeled A in FIG. 4, generates steam via an evaporation element 52, and introduces the steam into the cavity 14 through an outlet 54, as indicated by arrows labeled B in FIG. 4. The outlet 54 can be formed by an open top of the steam generator 46, as shown in FIG. 4. Alternatively, the outlet 54 can be formed in a lid that can be removed from steam generator 46 for cleaning or maintenance.

The water supply 48 can be provided by the user, such as through a port 56 on the console 29. The user can pour the water into the port 56 or use a portable supply vessel, as described in U.S. patent application Ser. No. 11/120,407, entitled “Steam Oven with Fluid Supply and Drain Vessel” and filed May 3, 2005, which is incorporated herein by reference in its entirety. Alternatively, the water supply 48 can be a main water supply that provides water to the household.

The evaporation element 52 can be any suitable element, such as a block heater, a body with a cast-in heating element, an induction heating element, or an electrical heating element, that converts water into steam substantially instantaneously. The evaporation element 52 can be configured, for example, so that water contacts an exterior surface of the evaporation element 52 to transfer heat to the water for conversion to steam or so that the water flows through the evaporation element for heat transfer. Flow of water to the steam generator 46 is controlled or metered, as will be described in more detail hereinafter, so that the water that enters the inlet 50 is substantially equal to an amount of water required to create a desired amount of steam at a desired steam generation rate as demanded by a selected manual or automatic cooking cycle. Thus, the steam generator 46 effectively generates steam on demand and in response to the water being supplied to the evaporation element 52, and little or no water collects in the steam generator 46. During steam generation, the evaporation element 52 can be always on or can be cycled according to a duty cycle. An exemplary duty cycle is the percentage of time the evaporation element 52 is on (i.e., power is supplied to the evaporation element) during a certain time interval, such as 1 minute.

The water supply 48 is fluidly coupled via the port 56 and a first fluid conduit 58 to a water reservoir 60 mounted within or near the oven 10. The water reservoir 60 is fluidly coupled between the water supply 48 and the steam generator 46 for storing the water from the water supply 48 before it is supplied to the steam generator 46. According to the illustrated embodiment, the water reservoir 60 is located vertically above the steam generator 46. Water flows from the first fluid conduit 58 into an inlet 62 of the water reservoir 60 and through a water filter 64 that purifies the water from the water supply 48 and prevents entry of foreign objects. The water reservoir 60 further comprises a water level sensor 66 that detects a level of water in the water reservoir 60 and communicates the level of water to the controller 30, which can display a signal on the control panel 28 to communicate the level of water to the user. The water level sensor 66 can be any suitable type of sensor, such as a conductivity sensor, a capacitive sensor, or a field effect sensor, and can be located in the water reservoir 60 in direct contact with the water, embedded in a wall of the water reservoir 60, or mounted on an external surface of a wall of the water reservoir 60. For example, the water reservoir 60 can be made of plastic and insert molded around the water level sensor 66 to form the water reservoir 60 with the water level sensor 66 embedded in a wall of the water reservoir 60. Optionally, the water reservoir 60 can further comprise a drain (not shown) to drain water from the water reservoir 60 when desired. Advantageously, the water in the water reservoir 60 is not heated and can, therefore, be drained at any time. If the water supply 48 is the main water supply, then the water reservoir 60 can further comprise a pressure valve (not shown) at the inlet 62 to control flow of water into the water reservoir 60 and to reduce the pressure of the water before or as it flows into the water reservoir 60.

When steam generation is desired, water leaves the water reservoir 60 through an outlet 68 to a second fluid conduit 70 that is fluidly coupled to the inlet 50 of the steam generator 46. The flow of water to the second fluid conduit 70 through the outlet 68 is controlled or metered by a fluid control element 72, such as a pump or a valve, which is operated by the controller 30 to provide a desired flow rate of water corresponding to the desired amount of steam and the desired steam generation rate demanded or set by the selected manual or automatic cooking cycle. Based on the selected manual or automatic cooking cycle, the controller 30 sets the desired amount of steam and/or the desired steam generation rate along with the desired flow rate of water corresponding to the desired amount of steam and/or the desired steam generation rate. The fluid control element 72 can be located at the outlet 68, as illustrated in FIG. 4, or downstream from the outlet 68. The fluid control element 72 is operable between an inactive condition wherein water does not flow from the water reservoir 60 to the steam generator 46 and an active condition wherein water flows from the water reservoir 60 to the steam generator 46 at the desired flow rate. The flow rate is relatively small such that the water supplied to the steam generator 46 does not collect in the steam generator 46 and instantaneously or almost instantaneously converts to steam. When the fluid control element 72 is a pump, the flow rate of the water is determined by a duty cycle of the pump. An exemplary duty cycle is the percentage of time the pump is on (i.e., power is supplied to the pump) during a certain time interval, such as 1 minute.

In operation, the user fills the water reservoir 60 with water from the water supply 48. The water flows from the port 56 and the first fluid conduit 58 into the water reservoir 60 through the inlet 62. The water passes though the water filter 64 and fills the water reservoir 60. The user continues to fill the water reservoir 60 until the water supply 48 is depleted or until the water level sensor 66 communicates to the controller 30 that the water reservoir 60 is full. The user selects a manual or automatic cooking cycle through the control panel 28, and the controller 30 begins the selected manual or automatic cooking cycle. When the selected manual or automatic cooking cycle demands introduction of steam into the cavity 14 to achieve a desired relative humidity, the controller 30 operates the steam system 44. In particular, the water flows through the outlet 68 of the water reservoir 60 and through the second fluid conduit 70 to the steam generator 46. The flow rate of the water through the second fluid conduit 70 is controlled by the fluid control element 72, which in the activated condition meters the water according to a desired rate of steam generation corresponding to the desired relative humidity. The metered water enters the steam generator 46 through the inlet 50 and is converted to steam by the evaporation element 52. According to one embodiment, the flow rate of the water is such that the water drips or sprays onto the evaporation element 52 and immediately converts to steam. The steam leaves the steam generator 46 through the outlet 54, and, according to the illustrated embodiment, is distributed through the cavity 14 by the convection fan 42.

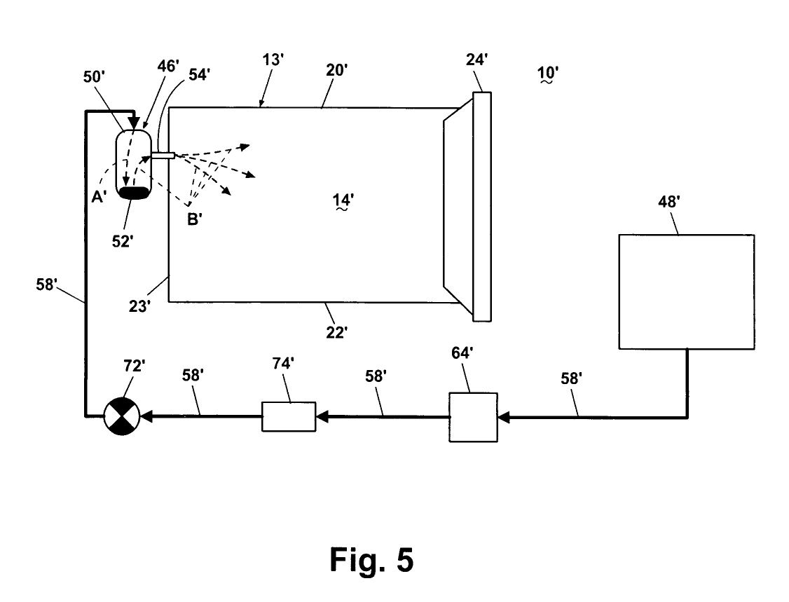

An alternative steam system 44′ is schematically illustrated in FIG. 5, where elements similar to those of the previous embodiment steam system described with respect to FIG. 4 are identified with the same reference numerals bearing a prime symbol (′). As shown in FIG. 5, the steam system 44′ comprises a steam generator 46′ that receives water from a water supply 48′ through an inlet 50′, as indicated by an arrow labeled A′ in FIG. 4, generates steam via an evaporation element 52′, and introduces the steam into the cavity 14′ through an outlet 54′, as indicated by arrows labeled B′ in FIG. 4. According to the illustrated embodiment, the steam generator 46′ is located exteriorly of the cavity 14′ and is mounted to the rear wall 23′ of the housing 13′ with the outlet 54′ fluidly communicating the steam generator 46′ with the cavity 14′. Mounting the steam generator 46 exteriorly of the cabinet facilitates maximizing cooking space in the cavity 14′.

As in the previous embodiment, the evaporation element 52′ can be any suitable element, such as a block heater, a body with a cast-in heating element, an induction heating element, or an electrical heating element, that converts water into steam substantially instantaneously. The evaporation element 52′ can be configured, for example, so that water contacts an exterior surface of the evaporation element 52′ to transfer heat to the water for conversion to steam or so that the water flows through the evaporation element for heat transfer. Flow of water to the steam generator 46′ is controlled or metered, as will be described in more detail hereinafter, so that the water that enters the inlet 50′ is substantially equal to an amount of water required to create a desired amount of steam at a desired steam generation rate according to a selected manual or automatic cooking cycle. Thus, the steam generator 46′ effectively generates steam on demand and in response to the water being supplied to the evaporation element 52′, and little or no water collects in the steam generator 46′. During steam generation, the evaporation element 52′ can be always on or can be cycled according to a duty cycle. An exemplary duty cycle is the percentage of time the evaporation element 52′ is on (i.e., power is supplied to the evaporation element) during a certain time interval, such as 1 minute.

According to the illustrated embodiment, the water supply 48′ comprises a main water supply that provides water to the household and is fluidly coupled to the steam generator 46′ via a fluid conduit 58′. A water filter 64′ located in the fluid conduit 58′ filters the water as it flows therethrough. Because the water from the main water supply is pressurized, the steam system further includes a pressure regulator 74′ in the fluid conduit 58′ to reduce the pressure to a desired pressure, such as a pressure in a range of about 6 psi to about 10 psi. Additionally, the steam system 44′ further comprises a fluid control element 72′, which is shown as a valve in the illustrated embodiment, downstream of the pressure regulator 74′ to meter the water supplied to the steam generator 46′. The fluid controller 72′ is operated by the controller 30′ to provide a desired flow rate of water corresponding to the desired amount of steam and the desired steam generation rate according to the selected manual or automatic cooking cycle. Based on the selected manual or automatic cooking cycle, the controller 30 sets the desired amount of steam and/or the desired steam generation rate along with the desired flow rate of water corresponding to the desired amount of steam and/or the desired steam generation rate. The fluid control element 72′ is operable between an inactive condition wherein water does not flow from the water reservoir 60′ to the steam generator 46′ and an active condition wherein water flows from the water reservoir 60′ to the steam generator 46′ at the desired flow rate. The flow rate is relatively small such that the water supplied to the steam generator 46′ does not collect in the steam generator 46′ and instantaneously or almost instantaneously converts to steam. An exemplary flow rate of water is about 35 mL/min.

In operation, the user selects a manual or automatic cooking cycle through the control panel 28′, and the controller 30′ begins the selected manual or automatic cooking cycle. When the selected manual or automatic cooking cycle demands introduction of steam into the cavity 14′ to achieve a desired relative humidity, the controller 30′ operates the steam system 44′. In particular, the water flows from the water supply 48′ and through the fluid conduit 58′ to the steam generator 46′. As the water passes through the fluid conduit 58′, the water filter 64′ filters the water, the pressure regulator 74′ reduces the pressure of the water, and the fluid control element 72′ in the activated condition controls the flow of water according to a desired the flow rate of the water. By controlling the flow rate, the fluid control element 72′ meters the water according to a desired amount of steam and a desired steam generation rate corresponding to the desired relative humidity. The metered water enters the steam generator 46′ through the inlet 50′ and is converted to steam by the evaporation element 52′. According to one embodiment, the flow rate of the water is such that the water drips or sprays onto the evaporation element 52′ and immediately converts to steam. The steam leaves the steam generator 46′ through the outlet 54′ and is thereby introduced into the cavity 14′. Optionally, the convection fan (not shown in FIG. 5) can facilitate distribution of the steam through the cavity 14′.

The steam system according to the invention is a cost effective and easily implemented system for instantaneously generating steam that is introduced into the cavity. Because steam is created substantially instantly from water accurately metered to the steam generator, the cooking cycle does not have to account for preheating a volume of water, as in a boiler system, or for a delay in introduction of steam into the cavity. The injection rate of steam is governed by the flow rate of the water, and the fluid control element controls or meters the flow rate of the water into the steam generator so that the steam introduced into the steam generator converts to steam instantaneously or almost instantaneously. Optionally, the oven can comprise a button on the control panel accessible to the user so that the user can manually inject steam into the cavity at any time during the selected manual or automatic cooking cycle. Additionally, when the desired amount of steam or the desired steam generation rate corresponds to a maximum relative humidity of the cavity, then the actual amount of steam introduced into the cavity or the actual steam generation rate (and the corresponding actual flow rate of water) can be equal to or greater than the desired values because the excess steam will escape the cavity through vents, and the cavity will maintain the maximum relative humidity.

While the invention has been specifically described in connection with certain specific embodiments thereof, it is to be understood that this is by way of illustration and not of limitation, and the scope of the appended claims should be construed as broadly as the prior art will permit.

What is claimed is:

1. An oven comprising:
a housing defining a cooking cavity;
a water supply;
a steam generator having an evaporation element for generating steam that is introduced into the cooking cavity;
a fluid control element fluidly coupling the water supply to the steam generator and operable to supply a metered amount of water to the evaporation element; and
a controller for implementing a steam cooking cycle and operably coupled to the steam generator and the fluid control element to supply the metered amount of water to the evaporation element to generate the steam as demanded by the steam cooking cycle.

2. The oven according to claim 1, wherein the metered amount of water corresponds to an amount of water required to sustain a desired rate of steam generation to meet the demand by the steam cooking cycle.

3. The oven according to claim 1, wherein the steam generator is configured to convert the metered amount of water to steam substantially instantaneously when the metered amount of water is supplied to the evaporation element.

4. The oven according to claim 1, wherein the steam generator is located inside the cavity.

5. The oven according to claim 1, wherein the steam generator is located exteriorly of the cavity.

6. The oven according to claim 1, wherein the steam generator comprises an inlet for receiving water from the water supply and a steam outlet operably connected to the cavity for introducing steam into the cavity.

7. The oven according to claim 6, wherein water that enters the steam generator through the inlet is directed onto the evaporation element.

8. The oven according to claim 1 and further comprising a water reservoir fluidly coupled between the water supply and the steam generator.

9. The oven according to claim 8, wherein the water reservoir is positioned above the evaporation element.

10. The oven according to claim 8, wherein the fluid control element is a pump.

11. The oven according to claim 1, wherein the water supply is a main water supply that provides pressurized water.

12. The oven according to claim 11 and further comprising a pressure regulator upstream of the steam generator to reduce the pressure of the water.

13. The oven according to claim 12, wherein the fluid control element is a valve.

14. The oven according to claim 1 and further comprising a water filter upstream of the steam generator.

15. A household oven comprising:
a housing defining a cooking cavity;
a water supply; and
a steam generator located exteriorly of the cavity and having an evaporation element fluidly coupled to the water supply and configured to generate steam for introduction into the cavity in response to water being supplied to the evaporation element.

16. The household oven according to claim 15, wherein the steam generator is mounted to the housing.

17. The household oven according to claim 16, wherein the steam generator is mounted to a rear wall of the housing.

18. The household oven according to claim 15 and further comprising a fluid control element fluidly coupling the water supply to the steam generator and operable to supply a metered amount of water to the evaporation element.

19. The household oven according to claim 18, wherein the metered amount of water corresponds to an amount of water required to sustain a desired rate of steam generation in accordance with a steam cooking cycle.

20. The household oven according to claim 18, wherein the water supply is a main water supply that provides pressurized water.

21. The household oven according to claim 20 and further comprising a pressure regulator upstream of the steam generator to reduce the pressure of the water.

22. The household oven according to claim 21, wherein the fluid control element is a valve.

23. The household oven according to claim 18 and further comprising a water reservoir fluidly coupled between the water supply and the steam generator.

24 The household oven according to claim 23, wherein the fluid control element is a pump.

25. The household oven according to claim 15 and further comprising a water filter upstream of the steam generator.

26. The household oven according to claim 15, wherein the steam generator is configured to convert the water to steam substantially instantaneously when the water is supplied to the evaporation element.
